(19) United States
(12) Patent Application Publication
(10) Pub. No.: US 2026/0285191 A1
(43) Pub. Date: Sep. 24, 2026

(54) MOUNTING APPARATUS

(71) Applicant: ISUZU MOTORS LIMITED, Yokohama-shi (JP)

(72) Inventors: Takuya FUJIWARA, Fujisawa-shi (JP); Takahiro SEKIUCHI, Fujisawa-shi (JP); Ibuki WATANABE, Fujisawa-shi (JP)

(21) Appl. No.: 19/531,724

(22) Filed: Feb. 6, 2026

(30) Foreign Application Priority Data
Mar. 21, 2025 (JP) 2025-047003

(51) Int. Cl. B60L 53/80; B60L 50/64; B60R 13/04

(52) U.S. Cl. CPC B60L 53/80; B60L 50/64; B60R 13/04

(57) ABSTRACT

A mounting apparatus includes: a coupling bracket coupled to a vehicle body frame; a mounting portion supported by the coupling bracket and on which the replaceable battery is removably placed; a movement mechanism configured to move the mounting portion, on which the replaceable battery is placed, in the vehicle width direction; and an under guard coupled to the coupling bracket and located below the movement mechanism in the vertical direction.

### CROSS-REFERENCE TO RELATED APPLICATIONS

The present application claims priority to Japanese Patent Application number 2025-47003, filed on March 21, 2025 contents of which are incorporated herein by reference in their entirety.

### BACKGROUND OF THE INVENTION

The present disclosure relates to a mounting apparatus on which a battery is placed. Japanese Unexamined Patent Application Publication No. 2024-110163 discloses a vehicle having a mounting portion configured to support a battery in a manner to be movable in a vehicle width direction. The mounting portion configured to support the battery is moved along the vehicle width direction by a movement mechanism.

However, the movement mechanism is exposed to the outside from below the mounting portion, and therefore foreign matter from the outside is likely to adhere to the movement mechanism. For example, when water is splashed onto the movement mechanism or mud adheres thereto, the movement mechanism may fail to operate appropriately.

### BRIEF SUMMARY OF THE INVENTION

The present disclosure has been made in view of these points, and its object is to suppress adhesion of foreign matter to a movement mechanism.

A first aspect of the present disclosure provides a mounting apparatus including: a coupling bracket coupled to a vehicle body frame; a mounting portion supported by the coupling bracket and on which a battery is removably placed; a movement mechanism configured to move the mounting portion, on which the battery is placed, in a vehicle width direction; and an under guard coupled to the coupling bracket and located below the movement mechanism in a vertical direction.

### BRIEF DESCRIPTION OF THE DRAWINGS

FIG. 1 is a schematic diagram illustrating a vehicle 1 according to one embodiment.

FIG. 2 is a perspective view showing a mounting apparatus 10 on which a replaceable battery 5 is placed.

FIG. 3 is a perspective view showing the mounting apparatus 10 with the replaceable battery 5 removed.

FIG. 4 is a plan view of the mounting apparatus 10 shown in FIG. 2.

FIG. 5 is a side view of the mounting apparatus 10 shown in FIG. 2.

FIG. 6 is a cross-sectional view taken along line A-A of FIG. 4.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Overview of a vehicle

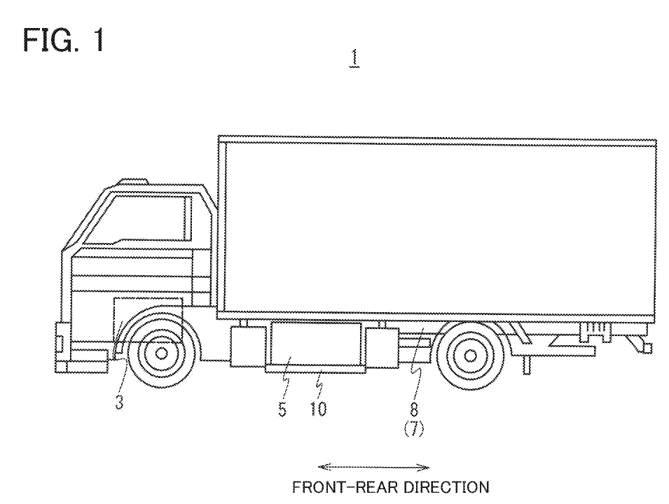

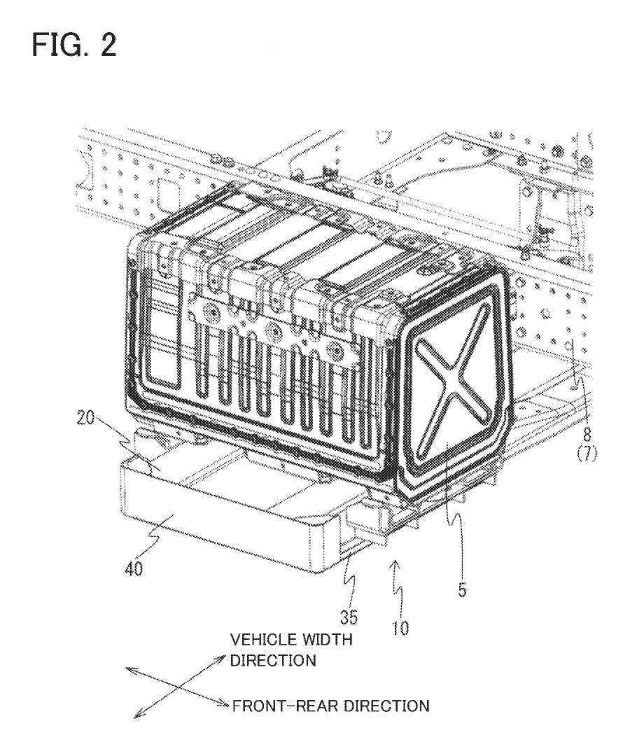

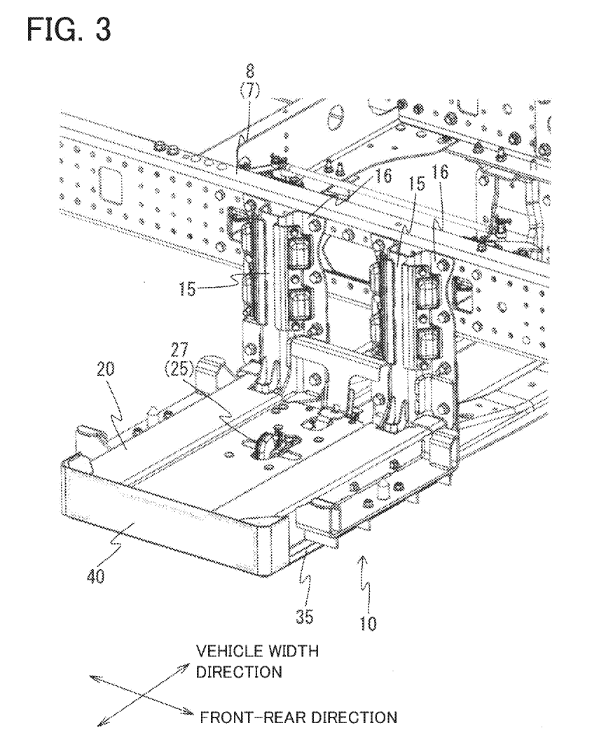

FIG. 1 is a schematic diagram illustrating a vehicle 1 according to one embodiment. FIG. 2 is a perspective view illustrating a mounting apparatus 10 on which a replaceable battery 5 is placed. FIG. 3 is a perspective view showing the mounting apparatus 10 with the replaceable battery 5 removed.

The vehicle 1 is an electric vehicle, and is, for example, a BEV (Battery Electric Vehicle). The vehicle 1 travels by driving the motor using electricity stored in a battery as a power source. Here, the vehicle 1 is a truck having a frame structure. As shown in FIG. 1, the vehicle 1 includes a motor 3, the replaceable battery 5, a vehicle body frame 7, and the mounting apparatus 10.

The motor 3 is a drive source for driving the vehicle 1. The motor 3 generates a driving force to be transmitted to the wheels of the vehicle 1. The motor 3 generates a driving force by receiving electric power from the replaceable battery 5.

The replaceable battery 5 is a battery that can be replaced. The replaceable battery 5 is a secondary battery that can be repeatedly charged. The replaceable battery 5 is, for example, a lithium-ion battery. The replaceable battery 5 can be charged from an external charger.

The vehicle body frame 7 is, as an example, a ladder frame and constitutes a framework supporting the vehicle 1. The motor 3 and the replaceable battery 5 are mounted on the vehicle body frame 7. In FIG. 1, the replaceable battery 5 is mounted on the left side (the near side in FIG. 1) in the vehicle width direction of the vehicle body frame 7, but in practice, the replaceable battery 5 is also mounted on the right side (the far side in FIG. 1) in the vehicle width direction of the vehicle body frame 7. That is, in FIG. 1, a plurality of replaceable batteries 5 (two replaceable batteries 5) are removably mounted on the vehicle body frame 7.

The vehicle body frame 7 has a pair of side frames 8. As shown in FIG. 1, the side frames 8 extend in the front-rear direction of the vehicle body of the vehicle 1. The motor 3 is fixed to the side frames 8.

The mounting apparatus 10 is, as shown in FIGS. 2 and 3, an apparatus on which the replaceable battery 5 is removably placed. The mounting apparatus 10 is attached to the vehicle body frame 7. Specifically, the mounting apparatus 10 is attached to the respective side frames 8 at both sides in the vehicle width direction. The mounting apparatus 10 is provided in a manner to be exposed to the outside, thereby facilitating placement of the replaceable battery 5 on the mounting apparatus 10 and removal of the replaceable battery 5 from the mounting apparatus 10.

The placement and removal of the replaceable battery 5 on and from the mounting apparatus 10 are performed automatically, for example, by a replacement device provided at a replacement station. The replacement device places and removes the replaceable battery 5 on and from the mounting apparatus 10 using an arm.

### Detailed configuration of the mounting apparatus

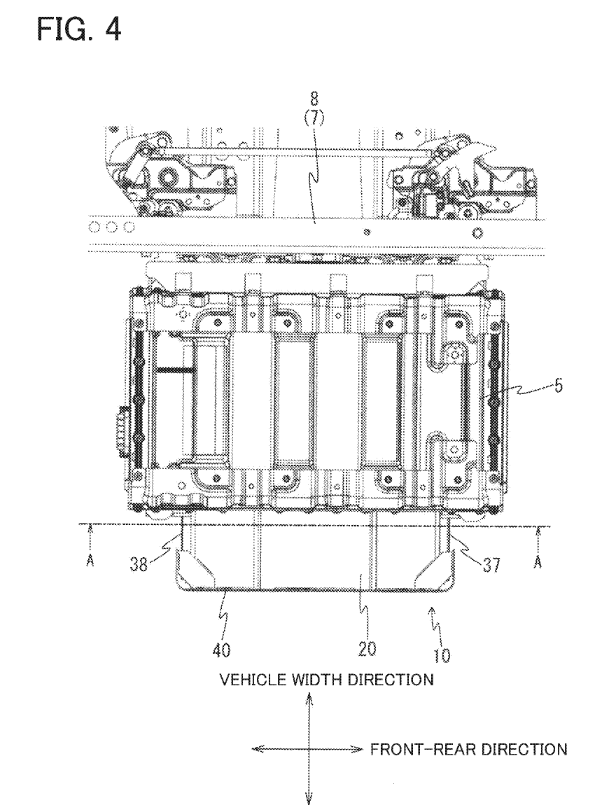

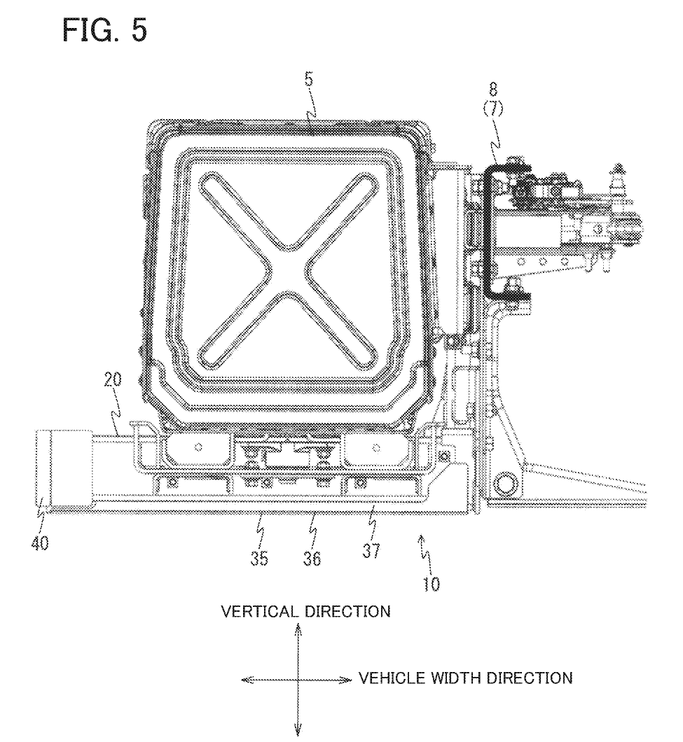

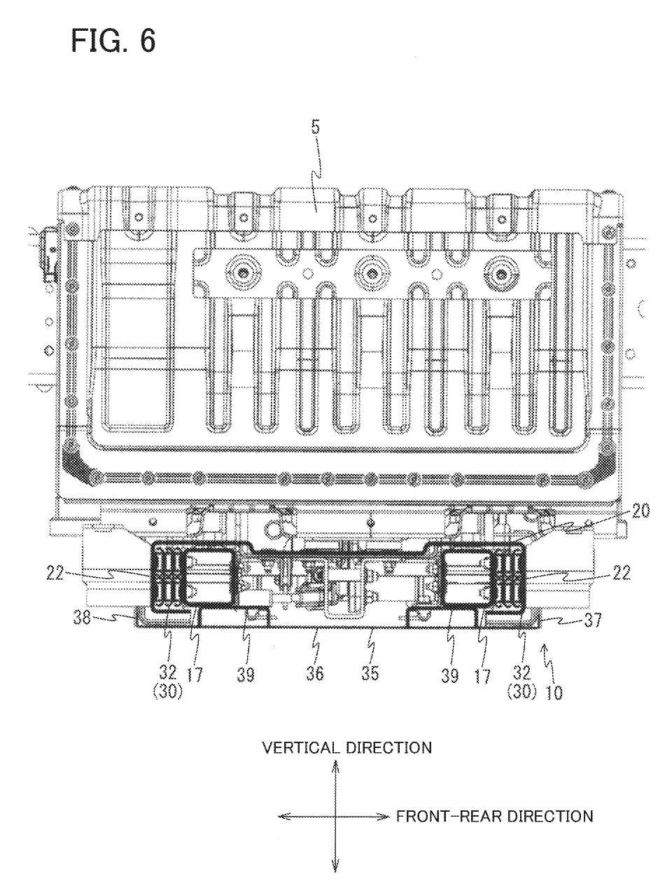

A detailed configuration of the mounting apparatus 10 will be described with reference to FIGS. 2 to 6. FIG. 4 is a plan view of the mounting apparatus 10 shown in FIG. 2. FIG. 5 is a side view of the mounting apparatus 10 shown in FIG. 2. FIG. 6 is a cross-sectional view taken along line A-A of FIG. 4.

Hereinafter, the configuration of the mounting apparatus 10 provided on the left side in the vehicle width direction shown in FIG. 2 will be described, but the configuration of the mounting apparatus 10 provided on the right side in the vehicle width direction is also the same. As shown in FIG. 3, the mounting apparatus 10 includes a coupling bracket 15, a mounting portion 20, a restraining portion 25, a movement mechanism 30 (FIG. 6), an under guard 35, and a side guard 40.

The coupling bracket 15 is a bracket coupled to the vehicle body frame 7. Specifically, the coupling bracket 15 is fixed to the side frame 8 by a fastening member. The coupling bracket 15 extends outward in the vehicle width direction from the side frame 8. The coupling bracket 15 has an L-shape when viewed from the front-rear direction, and includes a fixing portion 16 and a support portion 17. In the present embodiment, two coupling brackets 15 are provided at a predetermined interval in the front-rear direction.

The fixing portion 16 is a portion extending along the vertical direction, and the support portion 17 is a portion extending outward along the vehicle width direction. The support portion 17 is coupled to a lower end portion of the fixing portion 16. As shown in FIG. 6, the support portion 17 supports the mounting apparatus 10.

The mounting portion 20 is a portion on which the replaceable battery 5 is removably placed. The mounting portion 20 has a box shape with a predetermined thickness. The replaceable battery 5 is placed on the top plate of the mounting portion 20. The mounting portion 20 is located below the side frame 8 in the vertical direction.

The mounting portion 20 is coupled to the coupling bracket 15. Specifically, the mounting portion 20 is coupled to the support portion 17 of the coupling bracket 15. The mounting portion 20 is movably supported by the coupling bracket 15. The mounting portion 20 moves along the vehicle width direction. Specifically, the mounting portion 20 moves between a fixed position and a replacement position. The fixed position is a position where the replaceable battery 5 is fixed to the vehicle 1 as shown in FIG. 5. The replacement position is a position where the replaceable battery 5 is replaced. The replacement position is located outward of the fixed position in the vehicle width direction.

The restraining portion 25 restrains the replaceable battery 5 placed on the mounting portion 20. Specifically, the restraining portion 25 restricts movement of the replaceable battery 5 in a vertical direction relative to the mounting portion 20. The restraining portion 25 is provided in a central portion of the top plate of the mounting portion 20 in a manner to be exposed from the top plate.

The restraining portion 25 has a latch member 27 engageable with a striker provided at the bottom of the replaceable battery 5 (specifically, the bottom of the case of the replaceable battery 5). Due to the latch member 27 engaging with the striker of the replaceable battery 5, the vertical movement of the replaceable battery 5 is restricted. The latch member 27 is a movable member that pivots between an engagement position in which the latch member 27 engages with the striker and a disengagement position in which the engagement is released.

The movement mechanism 30 is a mechanism configured to move the mounting portion 20 along the vehicle width direction. The movement mechanism 30 is configured to move the mounting portion 20 on which the replaceable battery 5 is placed between the fixed position and the replacement position. The movement mechanism 30 is located below the mounting portion 20 in the vertical direction. In other words, the movement mechanism 30 is not covered by the mounting portion 20 and is exposed.

The movement mechanism 30 includes a rail portion 32 (FIG. 6) that guides the movement of the mounting portion 20 in the vehicle width direction. The rail portion 32 is a guide rail extending along the vehicle width direction. The rail portion 32 is provided below the mounting portion 20 at both end portions of the mounting portion 20 in the front-rear direction of the vehicle 1. The rail portion 32 guides a slider 22 provided on the mounting portion 20 in a manner to be movable in the vehicle width direction. Movement of the slider 22 along the rail portion 32 causes the mounting portion 20 to be positioned at the fixed position or the replacement position. In the movement mechanism 30, the rail portion 32 and the slider 22 are movable members.

The under guard 35 has a function of preventing foreign matter from adhering to the mounting apparatus 10 from below, with the mounting apparatus 10 being exposed to the outside. Specifically, the under guard 35 prevents water or mud from adhering to the restraining portion 25 including the movable members and the movement mechanism 30. The under guard 35 is located below the movement mechanism 30 and the restraining portion 25 in the vertical direction. Accordingly, the under guard 35 can prevent water or mud from adhering from below the movement mechanism 30 and the restraining portion 25, and therefore the movement mechanism 30 and the movable members of the restraining portion 25 can move appropriately.

The under guard 35 is coupled to the coupling bracket 15. Specifically, as shown in FIG. 6, the under guard 35 is fixed to the support portion 17 of the coupling bracket 15. The under guard 35 is fixed to the coupling bracket 15 while spaced apart from the movement mechanism 30. Thus, the under guard 35 can be provided even in a configuration in which the mounting portion 20 moves.

As shown in FIG. 6, the under guard 35 includes a flat plate portion 36, a first extending portion 37, a second extending portion 38, and a protruding portion 39. The flat plate portion 36 has a rectangular flat plate shape. The flat plate portion 36 faces the mounting portion 20. A rear end portion of the flat plate portion 36 in the front-rear direction extends rearward beyond a rear end of the mounting portion 20 in the front-rear direction. A front end portion of the flat plate portion 36 in the front-rear direction extends forward beyond a front end portion of the mounting portion 20 in the front-rear direction. Accordingly, the flat plate portion 36 facing the mounting portion 20 is provided over a wider area than the mounting portion 20, whereby adhesion of water or mud to the mounting portion 20 can be prevented.

The first extending portion 37 extends upward in the vertical direction from the rear end portion of the flat plate portion 36 in the front-rear direction. In other words, the first extending portion 37 is a bent portion of the rear end of the flat plate portion 36 in the front-rear direction. The first extending portion 37 is provided, whereby adhesion of water or mud to the rail portion 32 can be prevented.

The second extending portion 38 extends upward in the vertical direction from the front end portion of the flat plate portion 36 in the front-rear direction. In other words, the second extending portion 38 is a bent portion of the front end of the flat plate portion 36 in the front-rear direction. The second extending portion 38 is provided, whereby adhesion of water or mud to the rail portion 32 can be prevented. Furthermore, the first extending portion 37 and the second extending portion 38 are provided, whereby the rigidity of the under guard 35 having the flat plate portion 36 can be enhanced.

An upper end of the first extending portion 37 and an upper end of the second extending portion 38 may be located above a lower end of the rail portion 32 in the vertical direction. In this way, the first extending portion 37 and the second extending portion 38 can more effectively prevent adhesion of water or mud to the rail portion 32. Furthermore, the upper end of the first extending portion 37 and the upper end of the second extending portion 38 may be located above a lower end of the latch member 27 of the restraining portion 25 in the vertical direction.

The protruding portion 39 is a portion of the under guard 35 protruding upward in the vertical direction. Specifically, the protruding portion 39 protrudes upward from the flat plate portion 36. The protruding portion 39 has an inverted U shape (a so-called hat shape). The protruding portion 39 extends along the vehicle width direction.

Two protruding portions 39 are provided. The two protruding portions 39 are spaced apart from each other at a predetermined interval in the front-rear direction. As shown in FIG. 6, the two protruding portions 39 are respectively located below the support portion 17 in the vertical direction. Specifically, the protruding portion 39 is in contact with the lower surface of the support portion 17. Furthermore, the two protruding portions 39 are fixed to the coupling bracket 15. Specifically, the two protruding portions 39 are respectively fixed to the lower surface of the support portion 17 of the coupling bracket 15. Accordingly, even if, while the vehicle 1 is traveling, the under guard 35 comes into contact with an object (for example, a stone) on the road and an external force acts on the under guard 35, the external force is transmitted to and absorbed by the vehicle body frame 7 via the protruding portions 39 and the coupling bracket 15. As a result, damage to the mounting portion 20 and the movement mechanism 30 due to the external force can be prevented.

The side guard 40 has a function of preventing water or mud from adhering to the mounting portion 20 from outside the mounting portion 20 in the vehicle width direction. The side guard 40 is located outward in the vehicle width direction beyond the end surface of the mounting portion 20 in the vehicle width direction. The side guard 40 is provided so as to cover an outer end portion of the rail portion 32 in the vehicle width direction. Accordingly, it is possible to prevent water or mud from adhering to the end portion of the rail portion 32.

The side guard 40 is fixed to the mounting portion 20. For example, the side guard 40 is fixed to the side surface of the mounting portion 20. Thus, unlike the under guard 35, the side guard 40 is movable in the vehicle width direction together with the mounting portion 20.

### Effects of the embodiment

The mounting apparatus 10 of the above-described embodiment includes: the mounting portion 20 that is coupled to the coupling bracket 15 and on which the replaceable battery 5 is removably placed; the movement mechanism 30 configured to move the mounting portion 20, on which the replaceable battery 5 is placed, in the vehicle width direction; and the under guard 35 that is coupled to the coupling bracket 15 and located below the movement mechanism 30 in the vertical direction. Accordingly, since the under guard 35 can suppress the foreign matter such as water or mud from adhering to the movable members (specifically, the rail portion 32 and the slider 22) of the movement mechanism 30, the movement mechanism 30 can appropriately move the mounting portion 20. In addition, because the under guard 35 is coupled to the vehicle body frame 7 via the coupling bracket 15, even if an external force acts on the under guard 35, the under guard 35 can transmit the external force to the vehicle body frame 7 where the external force is absorbed. As a result, damage to the movement mechanism 30 resulting from transmission of the external force thereto can be suppressed.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Furthermore, new exemplary embodiments generated by arbitrary combinations of them are included in the exemplary embodiments. Furthermore, effects of the new exemplary embodiments brought by the combinations also have the effects of the original exemplary embodiments.

What is claimed is:

1. A mounting apparatus comprising:
a coupling bracket coupled to a vehicle body frame;
a mounting portion supported by the coupling bracket and on which a battery is removably placed;
a movement mechanism configured to move the mounting portion, on which the battery is placed, in a vehicle width direction; and
an under guard coupled to the coupling bracket and located below the movement mechanism in a vertical direction.

2. The mounting apparatus according to claim 1, wherein the under guard includes a flat plate portion having a flat plate shape and facing the mounting portion.

3. The mounting apparatus according to claim 2, wherein a rear end portion of the flat plate portion in a front-rear direction of the vehicle body frame extends rearward beyond a rear end of the mounting portion in the front-rear direction, and
a front end portion of the flat plate portion in the front-rear direction extends forward beyond a front end of the mounting portion in the front-rear direction.

4. The mounting apparatus according to claim 2, wherein the under guard includes:
a first extending portion that extends upward in the vertical direction from a rear end portion of the flat plate portion in the front-rear direction of the vehicle body frame, and
a second extending portion that extends upward in the vertical direction from a front end portion of the flat plate portion in the front-rear direction.

5. The mounting apparatus according to claim 4, wherein the movement mechanism includes a rail portion that extends along the vehicle width direction and guides movement of the mounting portion in the vehicle width direction, and
an upper end of the first extending portion and an upper end of the second extending portion are located above a lower end of the rail portion in the vertical direction.

6. The mounting apparatus according to claim 1, wherein the vehicle body frame includes a side frame extending in the front-rear direction of a vehicle body,
the coupling bracket is supported by the side frame and extends in the vehicle width direction,
the mounting portion is movably supported by the coupling bracket, and
the under guard is fixed to the coupling bracket while spaced apart from the movement mechanism.

7. The mounting apparatus according to claim 1, wherein the under guard includes a hat-shaped protruding portion protruding upward in the vertical direction, and
the protruding portion is fixed to the coupling bracket.

8. The mounting apparatus according to claim 7, wherein the coupling bracket includes a support portion extending outward along the vehicle width direction and supporting the mounting portion, and
the protruding portion is provided along the vehicle width direction and is fixed to a lower surface of the support portion.

9. The mounting apparatus according to claim 1, further comprising:
a side guard located outward in the vehicle width direction beyond an end surface of the mounting portion in the vehicle width direction, wherein
the side guard is fixed to the mounting portion.
